(19) United States
(12) Patent Application Publication
(10) Pub. No.: US 2011/0161820 A1
(43) Pub. Date: Jun. 30, 2011

(54) MANAGEMENT OF MULTIMEDIA SEGMENT DATA OVER A COMMUNICATIONS NETWORK

(76) Inventor: John Lee, Golden Beach, FL (US)

(21) Appl. No.: 12/651,437

(22) Filed: Dec. 31, 2009

(51) Int. Cl. G06F 3/01

(52) U.S. Cl. 715/723; 715/751

(57) ABSTRACT

A method for displaying video segment data associated with a video file can be provided. The method can include providing a graphical user interface to a user and receiving identifying information for a video file on a first server. The method can also include identifying the video file based and identifying at least one segment data file corresponding to the video file. Each segment data file includes at least a start time of a video segment, a stop time and a textual description of content of the video segment. The method can further include displaying in the graphical user interface a timeline representing a chronology of the video file and displaying, for each of the segment data files, the textual description and a graphic located adjacent to the timeline in a position corresponding to a chronological location of the start time and stop time in the video file.

### BACKGROUND OF THE INVENTION

1. Field of the Invention

The present invention relates to the field of multimedia files and more particularly to software that facilitates the creation and delivery of metadata about multimedia files over a communications network.

2. Description of the Related Art

In today's electronically connected world, an amazing assortment of television shows, movies, educational films, music videos and amateur-produced videos can all be accessed via the Internet or over various radio frequency broadcasts or with a set-top box. As a result, a consumer seeking entertainment in this era is often faced with a confusing amount of multimedia content choices. Though consumers generally prefer to have more options than less, there are obvious drawbacks in providing an overabundance of multimedia choices to any given individual in a 24 hour day.

For a consumer, it can often be difficult to filter through large amounts of multimedia and efficiently pinpoint content that satisfies their search parameters. Conventional search engines have made progress in the area of multimedia searching by providing interfaces directed specifically to searching for various types of multimedia. These conventional solutions, however, have their shortcomings. Often, conventional search engines provide a consumer looking for specific multimedia with multiple search results, thereby requiring the consumer to painstakingly scan through each result one-by-one. Also, conventional search engines are still known to include unrelated items in the search results, thereby creating irrelevant clutter that the consumer must filter through when wading through the search results. These shortcomings are annoying and time-consuming for the consumer seeking relevant multimedia.

Another drawback associated with multimedia in general is the tendency to require consumers to search through whole multimedia files for narrow/specific content. Often, a consumer is interested in only a portion or segment of a multimedia file. For example, a consumer may only be interested in a single 2-minute segment of a 90-minute soccer match. Thus, after the consumer finds a video file of the pertinent soccer match, he may then have to search through the entire video file for the relevant segment of the video file. In another example, a consumer may only be interested in a specific 10-minute interview from a 5-hour radio show. Thus, after the consumer finds an audio file of the pertinent radio show, he then must search through the audio file for the relevant segment of the audio file. Again, this is bothersome and time-consuming for a consumer seeking specific content. Additionally, since multimedia files can be large, it is wasteful for multimedia providers to transmit an entire multimedia file to a consumer when the consumer is only interested in one portion of the file. With the increasing shortage of bandwidth in today's world, it is imperative that bandwidth be conserved

One approach to the problem of searching through a multimedia file for desired content involves the use of content definitions in the comments of a video file. It is common for video sharing web sites, for example, to allow users to post comments related to each video on the web site. Sometimes, if a user identifies a noteworthy portion of the video file, the user will post a comment to the video file indicating at what point in the video file the noteworthy events occurs. This type of comment usually includes a description of the noteworthy portion of the video file in addition to a time indicator so that a subsequent user can fast forward the video to the indicated time (using a sliding interface widget) in order to view the noteworthy event. This implementation, although helpful, lacks organization and automation. The consumer looking for certain content in the video file must wade through sometimes hundreds of comments to find the comment pertaining to the pertinent content definition. This is time-consuming for a consumer. Additionally, the user is required to manually fast forward the video to the time indicator posted in the comment. Manual manipulation of a video file is not exact and often does not lead to the exact time indicator the user was seeking. Thus, the user is forced to use a trial-and-error approach to find the pertinent video content using a sliding interface widget. Again, this is burdensome and time-consuming for a consumer seeking certain content.

One problem with the content definition solution described above is the lack of grouped information about content definitions authored by other consumers. The content definition solution described above offers little, if any, information about similar or related content definitions authored by other consumers. This information could be helpful since it is often the case that consumers share similar proclivities in their selection of and description of content. There does not exist, however, an interface that allows consumers to browse or view grouped content definitions of other users when viewing the same multimedia.

Therefore, there is a need to overcome the deficiencies with the prior art and more particularly for a more efficient way to facilitate the creation and delivery of multimedia content definitions by consumers over a communications network.

### BRIEF SUMMARY OF THE INVENTION

Embodiments of the present invention address deficiencies of the art in respect to multimedia management and provide a novel and non-obvious method for displaying video segment data associated with a video file. In an embodiment of the invention, a method for displaying video segment data associated with a video file can be provided. The method can include providing a graphical user interface to a user over a communications network, receiving, via the graphical user interface, identifying information for a video file on a first server, identifying the video file based on the identifying information, identifying at least one segment data file corresponding to the video file based on the identifying information, wherein each segment data file includes at least a start time of a video segment, a stop time of the video segment and a textual description of content of the video segment defined by the start time and the stop time, displaying in the graphical user interface a timeline representing a chronology of the video file and displaying in the graphical user interface, for each one of the at least one segment data files, the textual description and a graphic located adjacent to the timeline in a position corresponding to a chronological location of the start time in the video file.

In another embodiment of the invention, an alternative method for displaying video segment data associated with a video file can be provided. The alternative method can include providing a graphical user interface to a user, receiving, via the graphical user interface, identifying information for a video file on a first server, transmitting the identifying information to a first server over a communications network, accessing the video file based on the identifying information, receiving from the first server, over the communications network, at least one segment data file corresponding to the video file based on the identifying information, wherein each segment data file includes at least a start time of a video segment, a stop time of the video segment and a textual description of content of the video segment defined by the start time and the stop time, displaying in the graphical user interface a timeline representing a chronology of the video file and displaying in the graphical user interface, for each one of the at least one segment data files, the textual description and a graphic located adjacent to the timeline in a position corresponding to a chronological location of the start time in the video file.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for facilitating the creation and delivery of multimedia segment data over a communications network, in accordance with one embodiment of the present invention;

FIG. 2 is a flow chart describing the control flow of the process for creation and delivery of multimedia segment data over a communications network, in accordance with one embodiment of the present invention; and

FIG. 3 is an illustration of a web browser providing an interface for the creation and delivery of multimedia segment data over a communications network, in accordance with one embodiment of the present invention.

### DETAILED DESCRIPTION OF THE INVENTION

The present invention solves the problems of the prior art by providing users with a tool that allows a user to visually view a multimedia file, as well as segment data that defines content within the multimedia file. The present invention displays for the user a timeline of the multimedia file and graphic icons that visually indicate within the timeline where certain events occurred. Textual comments area associated with the graphic icons wherein the comments textually describe the events occurring within the segment. Further, the present invention harnesses the power of the many by allowing users to create their own segments for others to view and further allows other users to vote on the accuracy of the segment create by any user. This provides a self-policing system that allows a plurality of users to define multimedia segments of interest and vet the accuracy of the multimedia segments, thereby eliminating the need for subsequent users with similar tastes from having to search a large multimedia file for the same content.

A further advantage of the present invention is eliminating the need for multimedia providers to transmit an entire multimedia file to a consumer when the consumer is only interested in one portion of the file. The present invention allows a multimedia provider to transmit only the desired portion of a multimedia file, thereby conserving bandwidth.

Another advantage of the present invention is the facility of a user to view the segments that were identified by other users. The user may also view, for any video selected, the number of users that affirmed each segment. These features are advantageous as they allow users to save the time and effort of identifying segments of a video for viewing, by simply selecting the segments identified by others. These features are further advantageous as they allow users to identify the popularity or recognition of videos, songs or sounds, as well as the popularity of certain segments, of those videos, songs or sounds.

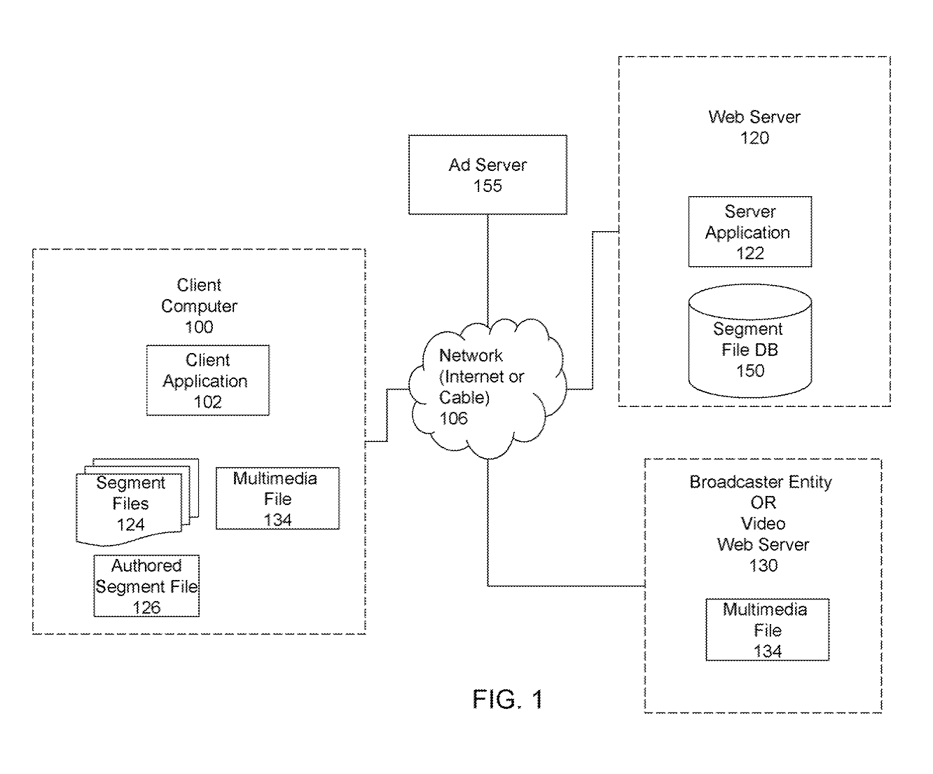

The features of the present invention will now be described with reference to FIGS. 1-3, which serve as exemplary embodiments of the present invention. Referring now to the drawing figures in which like reference designators refer to like elements, there is shown in FIG. 1 an illustration of a block diagram showing the network architecture of a system for facilitating the creation and delivery of multimedia segment data over a communications network. FIG. 1 shows an embodiment of the present invention wherein client computer 100 interacts with web server 120 and entity 130 over a network 106, which can be a circuit switched network, such as the Public Service Telephone Network or a packet switched network such as the Internet or the World Wide Web. Alternatively, the network 106 can be a cable communications network, including one or more cable television providers, or a satellite television communications network that includes direct broadcast satellite providers.

Web server 120 includes a software engine that delivers applications, videos and other data to client computer 100. Entity 130 can be a web server that includes a software engine that delivers videos to server 120 and/or client computer 100 based on search parameters or identifying information selected by the client. Alternatively, entity 130 can be a broadcaster entity, such as a cable television provider or a satellite television provider, which delivers videos to server 120 and/or client computer 100 based on search parameters or identifying information. The software engines of server 120 and entity 130 may perform other video delivering processes such as video streaming or any other standard for transferring multimedia data in a stream of packets that are interpreted and rendered, in real time, by a software application as the packets arrive. It should be noted that although FIG. 1 shows only one client computer 100, one web server 120, and one entity 130, the system of the present invention supports any number of client users and web servers/broadcaster entities connected via network 106.

In one embodiment of the present invention, the network application provided by the web server 120 of FIG. 1 is a client-server application having a client portion 102 that resides on client computer 100 and a server application 122 that resides on web server 120. For example, the network application can be a web interface that is accessed by client computer 100 via network 106. In another embodiment of the present invention, the web server 120 delivers to client 100 an application having only a client portion 102 that resides on client computer 100. For example, the application 102 can be a web browser extension or web browser add-on, which is an installable enhancement to a web browser. The web browser extension or web browser add-on may be written using any of the following technologies: CSS (Cascading Style Sheets), DOM (Document Object Model), JavaScript, XPCOM (Cross-Platform Component Object Model), XPConnect, XPI (Cross-Platform Installer), XUL (XML User interface Language).

Server application 122 and client application 102 include program logic comprising computer source code, scripting language code or interpreted language code that is compiled to produce computer instructions that perform various functions of the present invention. In one embodiment of the present invention, the program logic is a scripting language such as ECMAScript, CSS, XML (Extensible Markup Language), XSLT (Extensible Style-sheet Language Transformations), Javascript, AJAX (Asynchronous JavaScript and XML), XUL, JSP, PHP, and ASP (Active Server Pages).

FIG. 1 further shows that web server 120 includes a segment file database 150. Client computer 100 may also include its own database. Database 150 stores segment data created by users of server 120. Segment data is defined as a start time and an end time for a particular video file. Thus, segment data includes at least the following data: a start time indicator (i.e., a numerical value), an end time indicator and a unique video identifier (i.e., a text string or a numerical value). Segment data associated with a single segment may also include an accuracy rate (representing a percentage of users that have confirmed the accuracy of the segment data), a number representing the number of users that voted to affirm the accuracy of the segment, a number representing the number of users that voted against the accuracy of the segment, a number representing the total number of users that viewed the indicated segment, and a text description of the segment or a text comment on the segment.

Entity 130 can be a web server that stores videos and delivers them to clients, such as client 100 or server 120, over a communications network such as network 106. Server 130 may, for example, be a video sharing site available over the Internet. Alternatively, entity 130 can be a cable television or direct satellite broadcaster that broadcasts audio or video multimedia files 134.

Note that although entity 130 is shown as a separate entity, in one embodiment of the present invention, the functions of entity 130 may be integrated with another entity, such as web server 120. In this embodiment, a single entity provides server application 122, provides access to segment file database 150 and serves and/or broadcasts multimedia files 134. In yet another embodiment, the functions of server 120 and entity 130 are all integrated within the functionality of client 100.

FIG. 1 also shows an ad server 155 to store online ads and effectuate the provision of ads to the server application 122 and/or the client application 102. Ad server 155 performs the tasks of uploading ads to a requesting application, targeting ads to different users or according to certain criteria and optimizing ads based on results. Note that although server 155 is shown as a separate entity, in one embodiment of the present invention, the functions of server 155 may be integrated with another entity, such as web server 120 and/or entity 130.

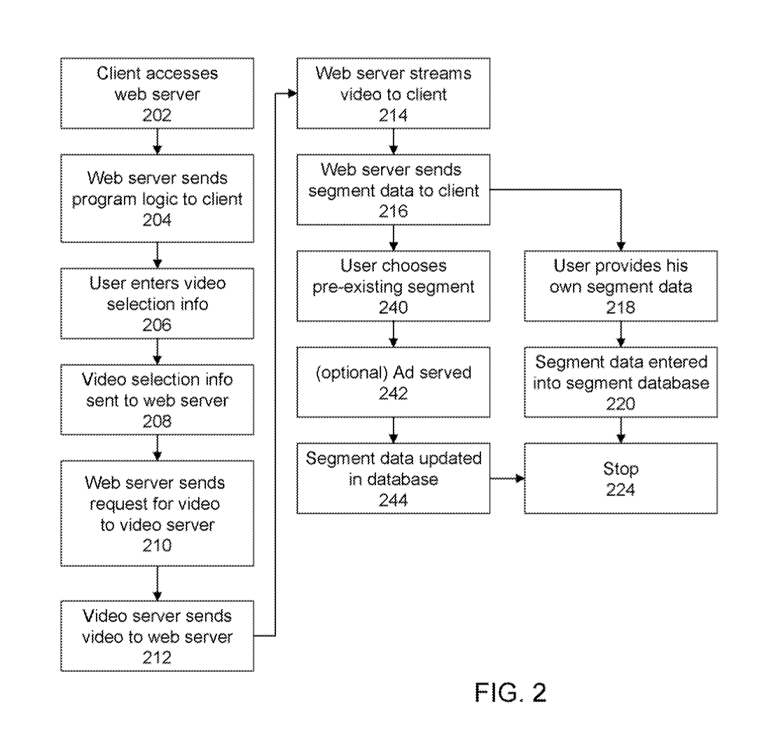

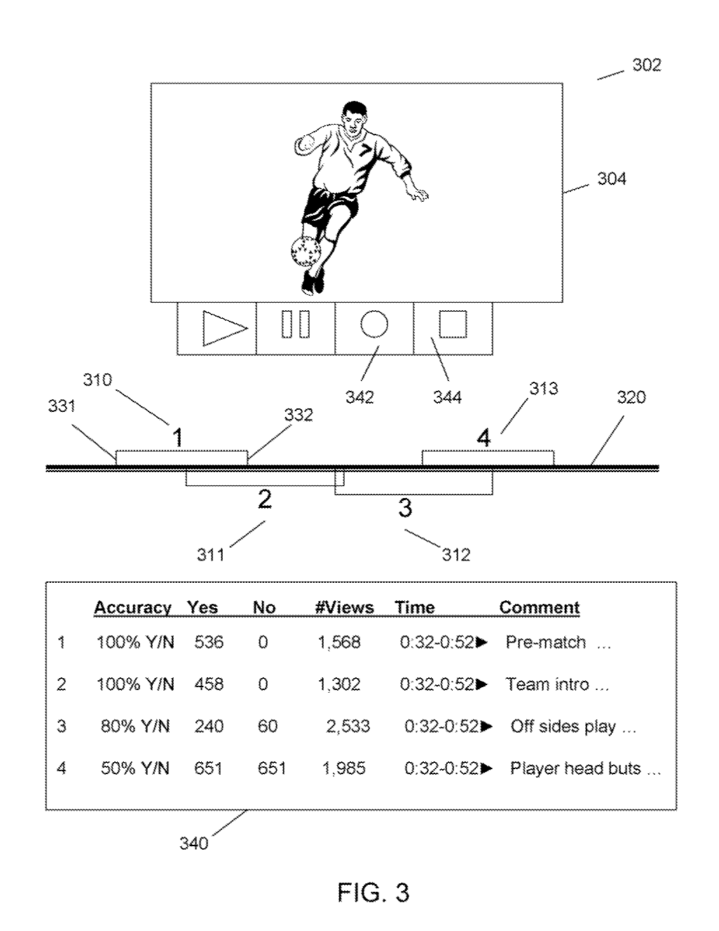

FIG. 2 is a flow chart describing the control flow of the process for creation and delivery of multimedia segment data over a communications network, in accordance with one embodiment of the present invention. The flow chart of FIG. 2 is described in association with FIG. 3, which is an illustration of a web browser providing an interface 302 for the creation and delivery of multimedia segment data over a communications network, in accordance with one embodiment of the present invention. Note that the following description with reference to FIGS. 2-3, which are directed to a video sharing web site, is provided for exemplary purposes only. The present invention additionally supports implementations that include content definitions for audio files, as well as implementations that that include multimedia provided by broadcaster entities.

In a first step 202, a client application 102, such as a web browser, executing on client computer 100 accesses web server 120 over network 106. Client application 102, may, for example, access the web site operated by web server 120 by sending an HTTP request to web server 120. In step 204, the server application 122 of web server 120 transmits program logic to client 100. The program logic displays a graphical user interface, such as interface 302 (see FIG. 3), on client 100. In step 206, the user of computer 100 enters identifying information for a video into the graphical user interface, wherein the identifying information can be a text string of key words, a URL or a click on an icon representing a video. In step 206, the user of computer 100 may also browse or search videos using various well known methods of searching for information via a graphical user interface.

In step 208, the identifying information entered by the user is transmitted to server 120, such as in an HTTP request. In step 210, the server application 122 of server 120 sends a request over network 106 to video web server 130 for the video identified by the user, wherein the request includes identifying information for the desired video. In step 212, the video web server 130 transmits the video file 134, or a portion thereof, to server 120 over network 106. The server 120 may store the received video file 134 in a database. In one alternative to steps 210-212, the desired video file 134 resides in a video database of server 120 and therefore the server application 122 simply searches for and accesses the desired video file 134 in its video database.

In one embodiment of the invention wherein the program logic of applications 102 and 122 are embodied in the program logic residing solely in client application 102, an alternative to steps 208-212 exists. In this alternative, the client application 102 of client 100 sends a request over network 106 to video web server 130 for the video identified by the user, wherein the request includes identifying information for the desired video. Subsequently, the video web server 130 transmits the video file 134, or a portion thereof, to client 100 over network 106. In another alternative to steps 210-212, the desired video resides in a video database of server 120 and therefore the server application 122 simply searches for and accesses the desired video in its video database.

The video file 134, or portion thereof, transferred from server 130 to server 120 and/or from server 120 to client 100 may exist in any of a variety of formats, such as AVI, FLV, MOV, MPEG, XVID, SWF, MPEG4, WMV. RM and DIVX. Further, the transfer of the video file 134 may be streamed, wherein video data is transferred in a stream of packets that are interpreted and rendered, in real time, by a software application as the packets arrive. Additionally, the transfer of the video file 134 may include compression and/or encryption upon transmission and decompression and/or decryption upon reception.

Next, in step 214, the server application 122 of server 120 sends a still image representing the video file 134 to the graphical user interface 302, as seen in video display 304. The still image may be the first frame or a representative frame of the video file 134. Alternatively, the server application 122 of server 120 streams the video file 134, or a portion thereof, to the graphical user interface 302, as seen in video display 304.

In step 216, server application 122 accesses various segment files 124 for the selected video from segment file database 150 and transmits the segment files 124 to client application 102 for display in interface 302. Note that FIG. 3 shows a timeline 320 for the selected video file 134, as well as the information in each segment file 124 (shown as segment data 310, 311, 312 and 313 in interface 302). The segment data 310-313 (garnered from corresponding segment files 124) includes, for each segment, a start time and an end time within the timeline 320 such that the location of a start time and an end time for each segment is visually indicated in the timeline 320. Segment data 310, for example, shows a line icon 331 indicating a start time within the timeline 320 and a line icon 332 indicating an end time within the timeline 320. Segment data 310 may also be shown as a bracket visually indicating the location of the start time and end time for the segment in the timeline 320. In one alternative, segment data may be shown as a single graphic icon (such as icon 331) situated on the timeline 320 solely at the indicated start time for the video segment.

In one embodiment of the present invention, segment data 310, 311, 312, 313, as displayed in interface 302, may also include additional information. Note that FIG. 3 also shows an information list 340 including a list of segments 310, 311, 312, 313. For each segment, the list shows: 1) an accuracy rate, 2) a “Yes” or “No” accuracy voting widget, 3) the number of users that voted to affirm the accuracy of the segment, 4) the number of users that voted against the accuracy of the segment, 5) the total number of users that viewed the indicated video segment, 6) a numerical start time and end time of the video segment in the timeline 320, 7) a play button that plays the segment in the video in display 304 when pressed, and 8) a text description of the video segment or a text comment on the video segment.

The accuracy rate of a segment in list 340 is a function of the percentage of users that affirmed the accuracy of the segment. Users viewing list 340 can vote on whether they agree with or disagree with the information in the list 340 about a particular video segment. If a user agrees with the information in the list 340 pertaining to a particular video segment, then the user may press the “Y” button adjacent to the accuracy percentage corresponding to the video segment. If a user disagrees with the information in the list 340 pertaining to a particular video segment (because, for example, the user believes the corresponding comment does not describe the video segment or because the corresponding time indicators do not show the event described in the comment), then the user may press the “N” button adjacent to the accuracy percentage corresponding to the video segment. The accuracy rate of a video segment in list 340 is therefore calculated based on the percentage of users that affirmed the accuracy of the segment by pressing the “Y” button adjacent to the accuracy percentage corresponding to the video segment.

The data in information list 340 may be organized and/or sorted for viewing in a variety of ways. For example, the list 340 can be sorted by the number of views of each video segment in decreasing format, sorted by the accuracy percentage of each video segment in decreasing format, sorted in chronological order according to the start time of each video segment or sorted by alphabetical order of the first word in the comments for each video segment.

Information list 340 may also include a download button for each video segment, wherein when the download button is pressed, a video file containing only the video segment is downloaded to the client application 102 over the network 106. Information list 340 may further include a link button for each video segment, wherein when the link button is pressed, the user is presented with the text of a unique hyperlink that references only the corresponding video segment. This hyperlink may then be emailed or transmitted to others so they may easily access the corresponding video segment.

Returning to the flow chart of FIG. 2, next, the user decides whether to view a preexisting video segment (such as segments 310-313, as shown in FIG. 3) in step 240, or to create or define his own video segment in step 218. In step 218, the user enters his own video segment data into interface 302. In one embodiment, the video in display 304 commences playing and the user presses the record button 342 when he desires his video segment to begin and presses the stop button 344 when he desires his video segment to end. In another embodiment, the user simply clicks on two locations in the timeline 320 to indicate a start time within the timeline 320 and an end time within the timeline 320. The user may then enter a text description of the video segment in a text field in interface 302. The segment data authored by the consumer in step 218 may be stored in a segment file 126. In step 220, the segment file 126 authored by the consumer is transmitted to the server 120 and server application 122 stores the segment file 126 in segment file database 150 for viewing by future users. In step 224, the flow of FIG. 2 ceases.

In step 240, the user decides to choose a preexisting segment, i.e., a preexisting video segment, already defined by a previous user. Note the preexisting segments 310-313 in FIG. 3. For example, the user may press one of the play buttons in list 340 corresponding to the desired pre-existing video segment in interface 302. Or the user may press a download button corresponding to the desired pre-existing video segment in interface 302. In response, the server 120 or the entity 130, whichever is transmitting the desired video to the client 100, transmits only the selected video segment to the client 100. Again, only the defined video segment, not the entire video file 134, is transmitted to the client 100, thereby conserving bandwidth and presenting the consumer solely the content he desires without unnecessary clutter or extraneous data.

Alternatively, in step 214 the server 120 or the entity 130 transmits the entire video file 134 to the client 100. However, during the download of the video file 134 to the client 100, in step 240 the consumer may click on one of the play buttons in list 340 corresponding to the desired pre-existing video segment in interface 302. In this alternative, the download process re-adjusts so that only the defined video segment, not the entire video file 134, is transmitted to the client 100, thereby conserving bandwidth.

In optional step 242, ad server 155 serves an ad to the client application 102, which ad is viewed within, before or after the video played in display 304 in step 240. In one embodiment, the ad served is targeted or related to the text comment associated with the video segment being viewed by the consumer.

In step 244, the segment data corresponding to the desired video segment is updated in segment database 150. The updating may comprise simply the addition of one unit to the count of the number of users who have viewed the corresponding video segment, to account for the user performing step 240.

In one embodiment of the present invention, the functionality of server 120 and entity 130 is integrated with client 100. In this embodiment, the process of creating and delivering multimedia segment data is similar to that described in FIG. 2, except that program logic residing on client 100 performs all of the functions described in FIG. 2 and there is no transfer of data over a communications network. In this embodiment, a user seeks and accesses a video file residing solely on the client 100. Upon finding the correct video file in client 100, the user seeks and accesses, in a segment file database residing solely on client 100, segment files that are pertinent to the video file. At this point, the user may either choose to view an existing video file (see steps 240-244 of FIG. 2) or define his own segment file (see steps 218-220), which is then stored solely on client 100.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allows a computer system to read such computer readable information.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allows a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for displaying video segment data associated with a video file, comprising:
providing a graphical user interface to a user over a communications network;
receiving, via the graphical user interface, identifying information for a video file on a first server;
identifying the video file based on the identifying information;
identifying at least one segment data file corresponding to the video file based on the identifying information, wherein each segment data file includes at least a start time of a video segment, a stop time of the video segment and a textual description of content of the video segment defined by the start time and the stop time;
displaying in the graphical user interface a timeline representing a chronology of the video file; and
displaying in the graphical user interface, for each one of the at least one segment data files, the textual description and a graphic located adjacent to the timeline in a position corresponding to a chronological location of the start time in the video file.

2. The method of claim 1, wherein the second step of displaying in the graphical user interface comprises:
displaying in the graphical user interface, for each one of the at least one segment data files, the textual description, a graphic located adjacent to the timeline in a position corresponding to a chronological location of the start time in the video file and a graphic located adjacent to the timeline in a position corresponding to a chronological location of the stop time in the video file.

3. The method of claim 1, wherein a segment data file further includes at least one of:
an accuracy rate representing a percentage of users that have confirmed accuracy of the segment data file;
a first number representing a number of users that voted to affirm accuracy of the segment data file;
a second number representing a number of users that voted against accuracy of the segment data file; and
a third number representing a number of users that viewed a video segment corresponding to the segment data file.

4. The method of claim 1, further comprising:
receiving, via the graphical user interface, additional segment data identifying a video segment of the video file, wherein the additional segment data is entered by the user;
creating a segment data file based on the additional segment data;
storing the segment data file that was created in connection with the video file.

5. The method of claim 3, further comprising:
receiving, via the graphical user interface, a vote by a user pertaining to accuracy of a segment data file;
accessing the segment data file; and
modifying data within the segment data file to reflect the vote, wherein at least one of the following data members of the segment data file is modified: the accuracy rate, the first number, the second number and the third number.

6. The method of claim 3, further comprising:
receiving, via the graphical user interface, a vote by a user confirming accuracy of a segment data file;
accessing the segment data file; and
modifying data within the segment data file to reflect the vote in the following way:
adding one to the first number, adding one to the third number and re-calculating the accuracy rate to the first number divided by the sum of the first number and the second number.

7. The method of claim 3, further comprising:
receiving, via the graphical user interface, a vote by a user negating accuracy of a segment data file;
accessing the segment data file; and
modifying data within the segment data file to reflect the vote in the following way: adding one to the second number, adding one to the third number and re-calculating the accuracy rate to the first number divided by the sum of the first number and the second number.

8. The method of claim 1, further comprising:
receiving, over the communications network, a user command to view a video segment, responsive to the user clicking on a graphic in the graphical user interface corresponding to a segment data file of the video segment.

9. The method of claim 8, further comprising:
transmitting to the graphical user interface, over the communications network, the video segment of the video file defined in the user command.

10. The method of claim 8, further comprising:
displaying an ad in the graphical user interface, wherein the ad corresponds to the textual comments of the segment data file corresponding to the video segment transmitted to the graphical user interface.

11. A method for displaying video segment data associated with a video file, comprising:
providing a graphical user interface to a user;
receiving, via the graphical user interface, identifying information for a video file on a first server;
transmitting the identifying information to a first server over a communications network;
accessing the video file based on the identifying information;
receiving from the first server, over the communications network, at least one segment data file corresponding to the video file based on the identifying information, wherein each segment data file includes at least a start time of a video segment, a stop time of the video segment and a textual description of content of the video segment defined by the start time and the stop time;
displaying in the graphical user interface a timeline representing a chronology of the video file; and
displaying in the graphical user interface, for each one of the at least one segment data files, the textual description and a graphic located adjacent to the timeline in a position corresponding to a chronological location of the start time in the video file.

12. The method of claim 11, wherein the second step of displaying in the graphical user interface comprises:
displaying in the graphical user interface, for each one of the at least one segment data files, the textual description, a graphic located adjacent to the timeline in a position corresponding to a chronological location of the start time in the video file and a graphic located adjacent to the timeline in a position corresponding to a chronological location of the stop time in the video file.

13. The method of claim 11, wherein a segment data file further includes at least one of:
an accuracy rate representing a percentage of users that have confirmed accuracy of the segment data file;
a first number representing a number of users that voted to affirm accuracy of the segment data file;
a second number representing a number of users that voted against accuracy of the segment data file; and
a third number representing a number of users that viewed a video segment corresponding to the segment data file.

14. The method of claim 11, further comprising:
receiving, via the graphical user interface, additional segment data identifying a video segment of the video file, wherein the additional segment data is entered by the user;
creating a segment data file based on the additional segment data; and
sending the segment data file to the first server over the communications network for storage in connection with the video file.

15. The method of claim 11, further comprising:
receiving a user command to view a video segment, responsive to the user clicking on a graphic in the graphical user interface corresponding to a segment data file of the video segment.

16. The method of claim 15, further comprising:
displaying in the graphical user interface the video segment of the video file defined in the user command.

17. The method of claim 16, further comprising:
receiving an ad for display in the graphical user interface, wherein the ad corresponds to the textual comments of the segment data file corresponding to the video segment transmitted to the graphical user interface.

18. A method for displaying video segment data associated with a video file, comprising:
providing a graphical user interface to a user;
receiving, via the graphical user interface, identifying information for a video file on a first server;
identifying the video file based on the identifying information;
identifying at least one segment data file corresponding to the video file based on the identifying information, wherein each segment data file includes at least a start time of a video segment, a stop time of the video segment and a textual description of content of the video segment defined by the start time and the stop time;
displaying in the graphical user interface a timeline representing a chronology of the video file; and
displaying in the graphical user interface, for each one of the at least one segment data files, the textual description, a graphic located adjacent to the timeline in a position corresponding to a chronological location of the start time in the video file and a graphic located adjacent to the timeline in a position corresponding to a chronological location of the stop time in the video file.

19. The method of claim 18, wherein a segment data file further includes at least one of:
an accuracy rate representing a percentage of users that have confirmed accuracy of the segment data file;
a first number representing a number of users that voted to affirm accuracy of the segment data file;
a second number representing a number of users that voted against accuracy of the segment data file; and
a third number representing a number of users that viewed a video segment corresponding to the segment data file.
